(19) United States
(12) Patent Application Publication
(10) Pub. No.: US 2026/0195887 A1
(43) Pub. Date: Jul. 9, 2026

(54) IMAGE PROCESSING METHOD FOR DETERMINING A PROCESS DISTURBANCE, AND IMAGE PROCESSING DEVICE

(71) Applicant: Siemens Energy Global GmbH & Co. KG, Munich, Bayern (DE)

(72) Inventors: Adrian Jacob, Berlin (DE); Lisa Kersting, Berlin (DE)

(73) Assignee: Siemens Energy Global GmbH & Co. KG, Munich, Bayern (DE)

(21) Appl. No.: 19/131,589

(22) PCT Filed: Oct. 25, 2023
(86) PCT No.: PCT/EP2023/079711

§ 371 Date: May 21, 2025

(30) Foreign Application Priority Data
Nov. 28, 2022 (DE) 10 2022 212 672.6

(51) Int. Cl. G06T 7/00; B33Y 50/02; G05B 19/4155; G06T 7/194; G06V 10/50; G06V 10/764

(52) U.S. Cl. CPC G06T 7/001; B33Y 50/02; G05B 19/4155; G06T 7/194; G06V 10/507; G06V 10/764; G06T 2207/20072; G06T 2207/20224; G06T 2207/30232; G06V 2201/06

(57) ABSTRACT

An image processing method for determining a process disturbance includes (i), capturing a plurality of images during an operating process or manufacturing process, (ii), classifying the images as those captured before, during and/or after a process event triggering the disturbance, (iii), calculating a background for each image capture during the process event by comparing same with other image captures before or after the process event, and, (iv), calculating an entirety of the disturbances from the image captures during the process event, from which image captures the calculated background has been removed.

### CROSS REFERENCE TO RELATED APPLICATIONS

This application is the US National Stage of International Application No. PCT/EP2023/079711 filed 25 Oct. 2023, and claims the benefit thereof, which is incorporated by reference herein in its entirety. The International Application claims the benefit of German Application No. DE 10 2022 212 672.6 filed 28 Nov. 2022.

### FIELD OF INVENTION

The present invention relates to an image processing method for determining a process disturbance or an artifact, and to a corresponding image processing device. In particular, the method is an image processing method for determining the amount of process fumes as a process disturbance in additive manufacturing. Furthermore, a corresponding monitoring system and a computer program product associated with the method are part of the present invention.

In particular, the process disturbance may be an artifact that distorts or disturbs the measurement result or the image capture. In contrast, the corresponding process may generally involve an operating method or a manufacturing method, preferably manufacturing methods with ever recurring similar process sequences. More specifically, the manufacturing method may be layered methods for the (powder-bed-based) manufacture of component parts.

### BACKGROUND OF INVENTION

Design and material properties of high-performance component parts are the subject of constant development, in order to increase or expand functionality and/or fields of application of the relevant component parts during use. In heat engines, in particular gas turbines, development is often aimed at increasingly higher application temperatures. To meet the challenges of evolving industrial requirements, for example, development strives in particular to increase the strength, thermomechanical load-bearing capacity and service life of component-part structures of this type.

Due to further technical advancement, generative or additive production is becoming increasingly attractive also for mass production of the abovementioned component parts, such as turbine blades or burner components for example.

Additive manufacturing methods (AM), also referred to colloquially as 3D printing, include selective laser melting (SLM) or laser sintering (SLS), or electron beam melting (EBM), for example, as powder-bed methods. Further additive methods are, for example, “Directed Energy Deposition (DED)” methods, in particular laser deposition welding, electron beam welding, or plasma-powder welding, wire welding, metallic powder injection molding, so-called “sheet lamination” methods, or thermal spraying methods (VPS LPPS, GDCS).

Additive production methods in particular have proven to be particularly advantageous for complex or filigree-designed component parts, for example labyrinthine structures, cooling structures and/or lightweight structures. In particular, additive production is advantageous owing to a particularly short chain of process steps, since a manufacturing step or production step for a component part can largely take place on the basis of an appropriate CAD file and the selection of appropriate production parameters.

The manufacture of gas turbine blades by means of the described powder-bed-based methods (LPBF, “Laser Powder Bed Fusion”) advantageously makes it possible to implement new geometries or concepts which reduce manufacturing costs and the set-up time and throughput time, optimize the manufacturing process and, for example, can improve the thermomechanical design or durability of the components. Components manufactured in a conventional manner, by injection molding for example, are still inferior to the additive production route, for example in terms of their design flexibility and also in respect of the required throughput time and the associated high costs and production complexity.

However, the powder-bed process inherently produces high thermal stresses in the structure of the component part. In particular, irradiation paths or irradiation vectors which are too short lead to pronounced overheating, which in turn leads to warpage of the structure.

Meanwhile, pronounced warpage during the set-up process easily leads to structural detachment, thermal deformation or geometric deviations outside a permissible tolerance.

In the LPBF method, inherently undesirable by-products are also produced in the production process, and these include process fumes. These process fumes cause shadowing effects and secondary effects as a result of interaction with the melt stream. This results in inaccuracies in the irradiation, corresponding process deviations and significantly also compromises in the quality of the structure of the component part to be manufactured. The influence of disruption of this type, such as that of process fumes, is normally locally dependent on the position on the build plate. This makes it difficult to attribute the defects arising in the component part to a specific influencing factor or irradiation parameter. The amount of fumes arising depends primarily on the material used, the shielding gas used and the process parameters.

Up until now, it has not been possible to reliably predict, determine or quantify the amount of arising fumes using currently available measurement methods.

### SUMMARY OF INVENTION

It is therefore an object of the present invention to specify means which allow process disturbances, such as said development of fumes in the course of the layered process to be reliably determined and/or quantified.

This object is achieved by the subject matter of the independent claims. Advantageous configurations are the subject matter of the dependent claims.

One aspect of the present invention relates to an image processing method for determining a process disturbance or an artifact, such as said procedural development of fumes. The method comprises capturing a plurality of images during the corresponding operating process or manufacturing process.

According to the invention, the images can be captured using conventional measures for image recording, process monitoring, such as optical tomography or camera captures in particular, for example CCD cameras or other image sensors.

The method further comprises classifying the images as those that were captured before, during and/or after a process event triggering the disturbance mentioned. The process event is preferably the trigger of the disturbance or measurement deviation; in the case of an additive manufacturing method, preferably the irradiation of the powder bed, which is the cause of the development of the process fumes.

The method further comprises calculating or correcting an image background (including image noise) for each image capture during the process event or each image capture that was captured during the process event, by comparing said image capture with further image captures before or after the process event (captures that were captured before and after the event).

The method further comprises calculating, defining and depicting an entirety, an amount or an intensity of the disturbances from the image captures during the process event, from which image captures the calculated background or a darkening effect (contrast shift), caused by the process fumes, and/or the image noise has been removed.

Advantageously this produces, in the course of the image processing or process monitoring, a background image that shows the partially irradiated component-part structures, but not the disturbing influence of the melt bath and of the process fumes.

Furthermore, using a measurement method or monitoring method of this type, process instructions (cf. CAM) with regard to the amount of, or reduction in, disturbance factors inherently arising in the process, such as the arising fumes, can be optimized. Indirectly, or as a result of further investigations, this of course also makes it possible to significantly increase the structural quality and dimensional stability of the corresponding component part to be manufactured.

In particular, with the present invention for the first time it is possible to develop reliable process parameters for the industrialized additive manufacture of component parts and in particular to improve the reproducibility thereof. Finally, an influence of the disturbance, which in the present case can involve not only the process fumes but also other disturbance effects, can be reliably quantified by the approach according to the invention and conclusions can be drawn therefrom regarding the process. In particular, the amount of fumes or the overall intensity of the disturbance variable to be determined via the image processing method, which disturbance variable arises when using a parameter set, can be determined accurately.

Improved process parameter development, which must be carried out for each new material and each new type of printer machine, indirectly also makes it possible to advantageously improve the quality of component parts.

Furthermore, the present invention also allows the development of the intensity or entirety of the disturbance over time to be determined and logged dynamically and/or in the course of the process monitoring of the underlying process. It is therefore possible to discover more extensive time-dependent insights, such as the deviations in fume development over time.

In one configuration, the classification of the images additionally takes place in individual recurring process steps during the underlying process.

In one configuration, the recurring process steps involve the manufacture of individual layers during a process for additively manufacturing the component part.

In one configuration, the background for each image capture during the process event (i.e. each image that is captured during the process event) is calculated pixel-wise. As a result of this configuration, the most accurate possible resolution and background correction is accomplished in the course of the method.

In one configuration, for the calculation of the background, in each case a very small difference in a measurement variable of the respective image, which was captured during the process event, from the capture before and after the process event is adopted or used as a basis for the calculation of the background. Advantageously, this gives a background image from which the disturbance effects such as the process fumes and any overexposure have been removed.

In one configuration, the plurality of images are captured using image sensors, preferably via a camera or via optical tomography, and corresponding contrasts or grayscales of the images are recorded or calculated as a measurement variable.

In one configuration, the image classification in each case comprises forming a temporal average value of a measurement variable, such as an optical image parameter, of those images that were captured before and after the process event. This averaging achieves in particular a particularly accurate background calculation while excluding the disturbance effects in the image processing in a particularly expedient manner.

In one configuration, the method comprises calculating or depicting a temporal profile of the entirety of the disturbances during the process event. This configuration achieves the advantages mentioned above. In particular, a temporal profile or a temporal profile of the entirety of the disturbing artifacts can be determined and, in the course of further processing of such data, can be correlated together with the recording of essential process parameters such as the laser output or irradiation output, a scanning speed and/or hatch spacing, for example, in order to draw further conclusions and in particular to develop a type of digital twin or model of the entire process. With the aid of this model, in turn it is possible to predict and provide a direct dependency of component-part quality on arising process fumes, for example via a setpoint-actual comparison, or a corresponding process tolerance for quality assurance.

In one configuration, an entirety of the disturbances during the process event is calculated via a histogram, which moreover also depicts image noise with the relative frequency over the recorded measurement variable. By means of this configuration, the entirety of the disturbances, such as the entirety of the process fumes, can be evaluated particularly clearly and depicted clearly.

In one configuration, the method is a method for determining the amount of process fumes as a disturbance or distortion of an image capture in powder-bed-based additive manufacturing.

A further aspect of the present invention relates to an image processing device which is designed to carry out, or is suitable for carrying out, an image processing method for determining the process disturbance (as described above).

A further aspect of the present invention relates to the use of an image processing device for the (isolated) quantification of process fumes in the, in particular powder-bed-based, additive manufacture of component parts.

A further aspect of the present invention relates to a monitoring system, for example as part of a monitoring solution in conventional additive manufacturing installations, comprising the image processing device described.

A further aspect of the present invention relates to a computer program or computer program product comprising commands which, when the program is executed by a computer, for example to control and/or monitor irradiation in an additive manufacturing installation, cause said computer to determine the disturbance as described above.

A CAD file or a computer program product can be provided, or be present, for example, as a (volatile or non-volatile) storage medium or reproduction medium, such as a memory card, a USB stick, a CD-ROM or DVD, for example, or also in the form of a downloadable file from a server and/or in a network. This can furthermore be provided, for example, in a wireless communication network by transmitting a corresponding file with the computer program product. A computer program product can contain program code, machine code or numerical control instructions, such as G code and/or other executable program instructions in general.

In one configuration, the computer program product relates to manufacturing instructions according to which an additive manufacturing installation is controlled by a corresponding computer program to manufacture the component part, for example via CAM means.

The computer program product can furthermore contain geometry data and/or construction data in a dataset or data format, such as a 3D format or as CAD data, or can comprise a program or program code for providing these data.

Configurations, features and/or advantages relating to the image processing method or the computer program (product) in the present case also relate to the image processing device and the monitoring system, and vice versa.

The expression “and/or” or “or” used here, if it is used in a series of two or more elements, means that each of the listed elements can be used alone or any combination of two or more of the listed elements can be used.

Further details of the invention will be described hereinafter with reference to the figures.

### BRIEF DESCRIPTION OF THE DRAWINGS

FIG. 1 shows a schematic perspective view of an additive manufacturing installation comprising an image processing device according to the invention.

FIG. 2 shows a simplified schematic flowchart indicating method steps according to the invention.

FIGS. 3 to 6 each indicate, using histograms, the image processing, inventive, quantitative determination of process fumes in additive manufacturing methods.

FIG. 7 further indicates, by way of example, the temporal profile of the determined amount of process fumes.

### DETAILED DESCRIPTION OF INVENTION

In the exemplary embodiments and figures, identical or identically acting elements may each be provided with the same reference signs. The depicted elements and the proportions thereof in relation to one another in principle are not to be regarded as being true to scale, rather individual elements may be depicted as being exaggeratedly thick or large in size, for better presentability and/or for better understanding.

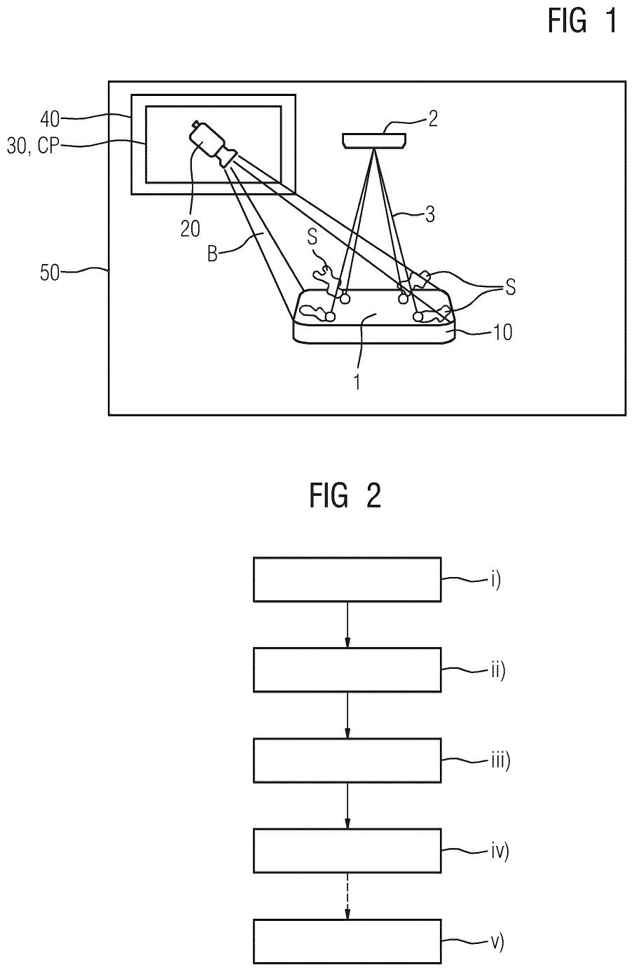

FIG. 1 shows an additive manufacturing installation 100. The manufacturing installation 100 is preferably configured as an LPBF installation and designed for the additive construction of component parts 10 or components from a powder bed. The installation 100 can also especially be an installation for electron beam melting.

Accordingly, the installation has a build platform on which the component-part geometry is manufactured, i.e. welded. The component part 10 is manufactured in layers from a powder or powder bed 1. To do this, the powder is distributed in layers on a build platform via a coating apparatus that is not characterized further. After each one of the powder layers is applied, regions of the layer are selectively melted with an energy beam, for example a laser or an electron beam 3, from an irradiation apparatus or beam source 2 in accordance with the prescribed geometry of the component part 10 and then solidified.

After each layer, the build platform is preferably lowered by one dimension corresponding to the layer thickness. This thickness is normally only between 20 and 40 μm, and therefore the entire process can easily comprise the selective irradiation of thousands to tens of thousands of layers. As a result of the only very locally acting energy input, high temperature gradients of 106 K/s or more, for example, can occur. Of course, during the construction and thereafter, the state of tension of the component part is also correspondingly great, which considerably complicates the additive manufacturing processes.

The geometry of the component part is usually specified by a CAD file (Computer Aided Design). After such a file has been imported into the manufacturing installation 100, the additive process subsequently initially requires a suitable irradiation strategy to be specified, for example by means of CAM (Computer Aided Manufacturing), with the result that the component-part geometry can also be divided into the individual layers.

As will be explained further with reference to the description of FIG. 2 (see further below), the image processing method according to the invention preferably involves the determination of process disturbances, in powder-bed-based additive manufacturing, wherein images I from a capture device 20, for example as part of an image processing device 30, are preferably captured in layers during the manufacturing process, in particular so as to determine and/or quantify the occurrence of process fumes D as a process disturbance.

The capture device 20 mentioned can capture the images I via expedient measures for image capture or process monitoring, for example, such as in particular camera captures, optical tomography, CCD cameras or other image sensors.

The image processing device 30 furthermore can be designed to determine the process disturbance D via or in the course of or using a computer program or computer program product, for example. Furthermore, the determined process disturbance (see below) or a disturbance entirety or even a temporal profile of the disturbance entirety mentioned can be a part or an integral of the computer program product resulting from a corresponding computer program.

FIG. 1 furthermore shows a monitoring system 40 for additive manufacturing comprising the image processing device 30.

FIG. 2 indicates the essential method steps according to the invention in a schematic simplified flowchart. Accordingly, the invention relates to an image processing method for determining the process disturbance D, comprising, (i), capturing a plurality of images I during the described operating process or manufacturing process.

Furthermore, the method comprises, (ii), classifying the images I as those that were captured before, during and/or after a process event triggering the disturbance D. It should be understood that this process event triggers the actual disturbance; in additive manufacturing methods, this event therefore involves irradiation by means of laser or electron beam in the paths and vectors prescribed by CAM, for example, in order to selectively solidify the structure in layers in accordance with the prescribed CAD component-part geometry.

The image classification can in each case preferably comprise forming a temporal average value of a measurement variable of the images I that were captured before and after the process event, such as brightness or grayscales, for example.

First, the captured images are preferably subdivided into individual layer images in accordance with a layer sequence during the manufacturing process. Subdivision continues-as described-after the time of the capture. If the capture time is before or after the exposure of a respective layer or its irradiation vectors, for example, the images are used for calculating the background and the image noise. However, if the image was captured during the exposure, it is used as a basis for determining the amount of disturbance induced by the fumes.

As described, the background or the image noise can preferably be calculated pixel-wise. For said calculation, in each case a very small difference in a measurement variable of the respective image I, which was captured during the process event, from the capture before and after the process event is preferably adopted for the calculation of the background.

In other words, for each image on which the build plate is exposed or imaged, the image background is preferably calculated individually. The background is composed of the images that were made before and after the exposure. For this, the image that was captured during the exposure is in each case compared pixel-by-pixel with the images that were captured before and after the exposure. If a pixel has a smaller difference in relation to the pixel in the image that is part of an image after the exposure, this pixel also assumes the value thereof in the background. If the difference is smaller in relation to the pixel in the image that was captured before the exposure, the pixel with the smaller difference adopts this value in the background. This advantageously gives a background image that shows the partially exposed component parts but not the melt bath and the process fumes.

By means of the image comparisons of the exposed image with those that are captured before and after the exposure and the adoption of the respectively smaller difference, in principle a more expedient result is delivered and in particular a light-dark contrast, which arises from the structure that is already solidified in layers, is minimized or eliminated.

The method furthermore comprises, (iii), calculating a background and/or image noise for each image capture I during the process event, by comparing said background and/or image noise with further image captures before or after the process event.

The method furthermore comprises, (iv), calculating an entirety E of the disturbances D from the image captures I during the process event, from which image captures I the calculated background has been removed.

In particular, the amount of fumes per image can be determined by an evaluation algorithm that is applied to the captured images. The measured data are—as a result of the described background calculation or background correction—advantageously independent of the image noise that arises in the corresponding image sensor.

With this approach, the present invention makes a considerable contribution to significantly improving process monitoring and even to optimizing the parameter set that is to be developed on the basis of material and design.

Preferably, the plurality of images I are finally captured using image sensors and corresponding grayscales or black-white contrasts of the images are recorded as a measurement variable.

These brightness values or grayscales of the pixels in the captured images are actually composed of different influences. Most of the pixels absorb the light that is—in the present case—reflected by the powder bed 1. As soon as there are process fumes D above the powder bed 1, the reflected light is deflected or scattered and the brightness value decreases. However, if the powder bed 1 is exposed by the laser beam 3, the brightness value in the melt bath increases. Furthermore, an inherent measurement deviation due to image noise occurs for each pixel during image capture.

The images that were captured shortly before and after the exposure normally show the build platform or manufacturing surface for a few seconds (cf. FIG. 1). These images in principle illustrate a similar scenario or the same scenario, but may differ slightly due to the image noise. The noise contrast, however, is weak enough for the average values of the pixels to each be assumed to be approximately constant and the corresponding noise function to be sufficiently accurately distributed as normal. Therefore, the average of the corresponding images over time is calculated first.

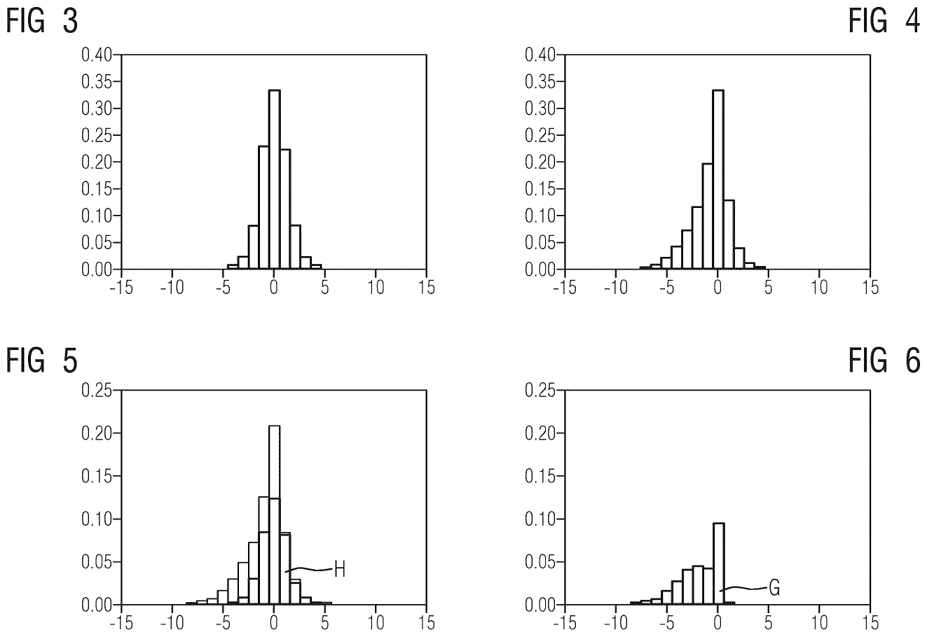

As already indicated above, the differences in the pixels from this average image and the other or further images are preferably calculated, which are then subsequently depicted in a histogram (see FIGS. 3 to 6 further below). The histogram displayed correspondingly in this way also displays the image noise, or comprises it. In this sense, the histogram allows the entirety E of the disturbances to be calculated and/or depicted for the first time during the process event.

FIG. 3 uses a simple histogram to show a relative frequency of the image noise plotted over individual difference classes of the pixel measured values of the image sensor, for example a brightness value, gray value or grayscale.

FIG. 4 shows—analogously to FIG. 3—a histogram of the overall image-sensor signal, i.e. the captured process fumes including image noise.

In an analogous depiction, FIG. 5 shows said difference in the “overall signal” in relation to the background or background signal B. In other words, this calculated background image is withdrawn from the respective image that was captured during the exposure. The corresponding histogram is then formed from the resulting difference image. This histogram is composed of the influences mentioned. As is known, (back-scattered) laser light only takes on values at the upper end or right-hand part of the histogram.

Referring to the depiction in FIG. 6, it can furthermore be seen that this right-hand part was consequently cut out, i.e. set to zero. The right-hand and therefore positive side of the histogram is thus influenced only by the image noise of the background (see above). A factor between the two distributions can now be determined via a numerical optimizer, such that both histograms lie as close as possible to one another in the positive region. In this way, an overexposure error in the determined disturbance, or its entirety, is virtually removed. Instead of the numerical optimizer mentioned, another expedient fitting algorithm or an expedient regression analysis or compensation calculation, for example, can be used.

The described subtraction of the individual histograms produces a distribution that is advantageously only influenced by the deflection of the process fumes.

The high value of the relative frequency in the individual histograms in FIGS. 3 to 6 with a difference of zero reflects the fact that a gray value or a pixel brightness beyond the “limit” of the measurement accuracy of a corresponding image sensor or capture appliance of the sensor must be taken into account cropped or scaled in each case.

The amount of the disturbance entirety E or of the process fumes D can subsequently be formed via the sum of the products of each difference value with the respective frequency. The amount of fumes on the respective image is therefore determined independently of the image noise of the background. In the present case of the histogrammatic depiction, the determination of the amount of fumes is achieved in particular by the sum of the relative frequencies across the individual classes or difference bars.

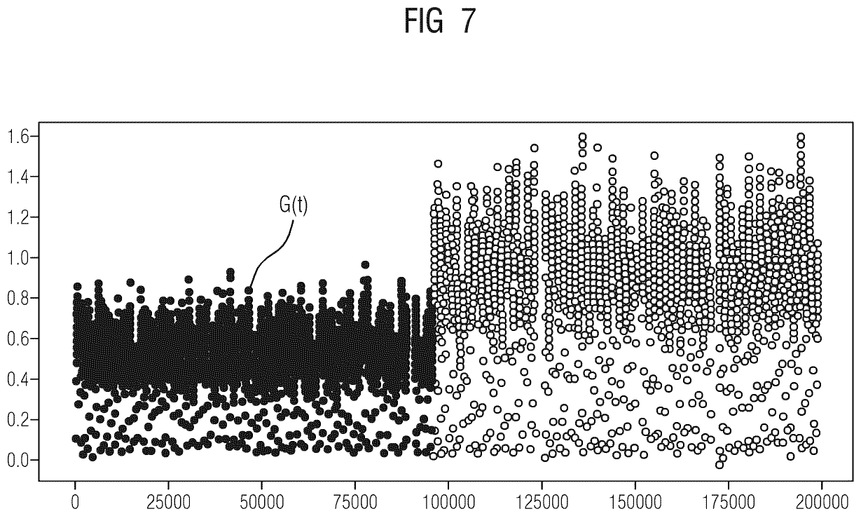

FIG. 7 indicates, only abstractly and by way of example, the temporal profile E(t) of the amount of the determined process fumes D over time. Since this step is an optional step that is not absolutely essential for the invention, it is provided in the flowchart in FIG. 2 only with dashed connecting lines.

Therefore, advantageously a temporal profile of the amount of process fumes over the build plate can furthermore be ascertained. This temporal profile can be used, inter alia, for comparing different parameters or for process monitoring in general.

Without limiting the generality, the present imaging method for determining process disturbance can alternatively apply to other methods, for example laser-based, standardized or automated operating methods.

1. An image processing method for determining an amount of process fumes in additive manufacturing as a process disturbance, comprising:
(i) capturing a plurality of images (I) during an operating process or manufacturing process,
(ii) classifying the images (I) as those that were captured before, during and/or after a process event triggering the disturbance (D), wherein the classification of the images (I) additionally takes place in individual recurring process steps during the operating process or manufacturing process and wherein the recurring process steps involve the manufacture of individual layers during a manufacturing process,
(iii) calculating a background for each image capture (I) during the process event, by comparing said image capture (I) with further image captures before or after the process event, and
(iv) calculating an entirety (E) of the disturbances (D) from the image captures (I) during the process event, from which image captures (I) the calculated background has been removed.

2. The method as claimed in claim 1,
wherein the background for each image capture (I) during the process event is calculated pixel-wise.

3. The method as claimed in claim 1,
wherein, for the calculation of the background, in each case a very small difference in a measurement variable of the respective image (I), which was captured during the process event, from the capture before and after the process event is adopted for the calculation of the background.

4. The method as claimed in claim 1,
wherein the plurality of images (I) are captured using image sensors and grayscales of the images are recorded as a measurement variable.

5. The method as claimed in claim 1,
wherein the image classification in each case comprises forming a temporal average value of a measurement variable of those images (I) that were captured before and after the process event.

6. The method as claimed in claim 1, further comprising:
calculating a temporal profile (E(t), v) of the entirety (E) of the disturbances (D) during the process event.

7. The method as claimed in claim 1,
wherein the entirety (E) of the disturbances (D) during the process event is calculated via a histogram.

8. An image processing device,
which is designed to carry out an image processing method for determining a disturbance (D) as claimed in claim 1.

9. A monitoring system for additive manufacturing, comprising:
an image processing device as claimed in claim 8.

10. A non-transitory computer readable media, comprising:
commands stored thereon which, when the commands are executed by a computer, cause said computer to execute the method as claimed in claim 1.

11. The non-transitory computer readable media of claim 10,
wherein the method executed is adapted to control and/or monitor irradiation in an additive manufacturing installation.

12. The method as claimed in claim 1, further comprising:
controlling irradiation in an additive manufacturing installation based on the determined amount of process fumes in additive manufacturing as the process disturbance.
